(19) United States
(12) Patent Application Publication
(10) Pub. No.: US 2020/0054529 A1
(43) Pub. Date: Feb. 20, 2020

(54) Pill dispenser system for before and after meals

(71) Applicant: Levete Wallace, Houston, TX (US)

(72) Inventor: Levete Wallace, Houston, TX (US)

(21) Appl. No.: 16/102,884

(22) Filed: Aug. 14, 2018

(51) Int. Cl. A61J 7/00

(52) U.S. Cl. CPC A61J 7/0069

(57) ABSTRACT

The invention is directed to a pill dispenser system for before and after meals. The system provides seven pill dispensers, corresponding to the days of the week and identifiable by printed tabs, which are provided. Each pill dispenser provides four sections, each corresponding to a meal or snack which is served during the course of a day. Each section further provides two compartments with tight fitting snap-down lids, corresponding to the period before and after each meal or snack. The pill dispensers are provided on a tray in sets of seven, corresponding to the seven days of the week. The tray provides a hinged tray lid which may be secured by a latch.

This application relates back to, and claims the priority of Provisional Patent Application No. 62/567,160 filed on Oct. 2, 2017.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to home health care equipment and accessories, and in particular to a pill dispenser system for before and after meals. Millions of Americans have used conventional pill dispensers, which either provide a single pill compartment for each day of the week, or multiple compartments representing the various times of day when each pill is to be taken. Unfortunately, some prescriptions specify that a medication must be taken either before a meal, or after a meal. Many users are elderly or disabled, and easily become confused regarding whether a particular pill should be taken before or after eating.

A search of the prior art reveals various devices which have been developed to address this set of problems, or related problems. None are closely related to the present invention, but several include features which resemble those of the present invention. Each has proven to be less than satisfactory for the present purpose in its own way.

Recording pill dispenser, U.S. Pat. No. 3,477,561 (priority Jun. 26, 1968), provides a pill dispenser which has a cylindrical container having a dispensing opening at the top thereof which is closed by a vertically reciprocating closure and which is moved into open position by a rotatable cam band. Means are provided on the band for recording the last time that pills were dispensed from the container. The primary object of the invention is to provide a pill dispenser which will record the time of the dispensing of the pills.

Pill dispenser having ratchet-action follower, U.S. Pat. No. 3,612,349 (priority Sep. 5, 1969), provides a device for dispensing pills and the like and including a hollow member having an exit opening at one end thereof with an actuator slidable in the hollow member. The actuator has a pill support on one end thereof and is biased to normally block the exit opening while being movable to expose the exit opening. A plunger engages one end of a group of pills to maintain the other end of the pills in engagement with the pill support. The plunger cooperates with the actuator and hollow member to move relative to the hollow member when the actuator is moved to expose the exit opening and is fixed relative to the hollow member when the actuator is returned to close the exit opening. Indicia are normally packed with the device and the indicia comprises a strip having indicators serially arranged and corresponding to the respective days of the week. There are seven more indicators than there are pills in the device so that the starting date for taking the pills may be aligned with the plunger and serve as a reminder as to whether a pill has been taken for any given day.

Pill dispenser with indicating dial, U.S. Pat. No. 3,495,567 (priority Feb. 20, 1968), provides a dispenser which has a base with individual pill compartments and a cover with a pill exit rotatably mounted on the base. An indicating dial is rotatably mounted between the cover and base and is in motion transmitting engagement with the base whereby the dial is advanced one indicium each time the cover is rotated to an adjacent pill. However, the motion-transmitting means cooperating between the base and dial is of a reduced magnitude at the compartment for the pill designated as the first to be removed in the sequential dosage prescription. At this point the dial may be rotated on a portion accessible externally of the cover and base to cause overriding of the motion-transmitting means. The dial is rotated in this fashion until the correct indicium appears. Although the motion-transmitting means is of a U.S. Pat. No. 3,495,567 Patented Feb. 17, 1970 reduced magnitude at this point, it is nevertheless sufficient to advance the dial when the cover is rotated for taking the second pill.

Pill dispenser with sequential dispensing and indicating cap, U.S. Pat. No. 4,432,300 (priority Jun. 1, 1981), provides a pill dispenser having a rotatable cap with special opening means for dispensing a pill at the proper time for medication. The dispenser comprises a housing having openings corresponding to each time for medication in a repetitive cycle such as in a day or week. A rotatable indicator cap or lid has means cooperating with the housing to provide by a detent means stagewise movement and in a modification ratchet means for one way rotation. An opening in the cap is provided for view of indicia means on the top of the housing with a selected time for taking indicia. When the time for taking the pill arrives the cap is rotated to present a dispensing opening in registry with one of the housing openings for dispensing a pill. The indicator cap and a bottom fill cap may be press fitted on the bottle housing for simple fabrication and refilling the contents.

Automatic pill dispenser and method of administering medical pills, U.S. Pat. No. 4,573,606 (priority Sep. 12, 1981), provides an automatic pill dispenser for dispensing medical pills having different prescribed administration schedules includes a plurality of pill storage compartments each capable of holding more than one pill, an automatic release mechanism for dispensing pills at predetermined time intervals corresponding with their respective administration schedules, and a pill receptacle coupled to a pill detector such that a pill dispensed from the pill dispenser and received by the receptacle causes the pill dispenser to generate a signal to alert the patient to take the dispensed medicine. Twelve storage compartments, arranged in a ring about a vertically rotating wheel, are preloaded by a patient with all pills prescribed to be taken during a 24-hour period. The patient loads pills into individual storage compartments according to a loading code corresponding to the respective administration schedules of the pills. The pill dispenser then automatically sequentially rotates the storage compartments over a trapdoor which operates to empty each compartment positioned thereover. A photoelectric detector, having a light beam traveling vertically through a cup into which pills are dispensed, detects pills therein and responds by alerting the patient with an audible or visual signal. The light source also serves as a night light. A preloadable pill storage canister is also disclosed which may be preloaded by a pharmacist and simply inserted into the pill dispenser by the patient for automatic pill dispensing. A method of dispensing medical pills having different prescribed administration schedules is also described.

Sanitary pill dispenser with indicator, U.S. Pat. No. 3,410,450 (priority Jun. 16, 1967), provides a sanitary pill container and dispenser with indicator comprising a small fiat receptacle whose interior is partitioned to define a spiral chamber, a tape bearing pills at spaced intervals disposed in said spiral chamber and having one end secured to a spindle, an external operating knob connected to said spindle for winding the tape to successively move the pills thereon toward a release position and a dispensing aperture, and an indicator dial operatively connected to the tape to indicate the release of each successive pill. In one embodiment, the spiral tape is provided with upstanding flaps which together with the walls of the spiral chamber define individual pill holding compartments along the tape. In a second embodiment, the tape is formed of superimposed strips sealed together at spaced intervals to define pill holding compartments between the strips, and the pills are released by separating the strips by operation of the external knob.

Pill dispenser device, U.S. Pat. No. 4,078,661 (priority Dec. 20, 1976), provides a pill dispenser comprising a circular base provided with a plurality of circumferentially spaced compartments defined therein. A knurled actuator ring is provided having the same circumference as the base which is affixed to the base outside of the compartments therein and is rotatable within limits defined by an opening in the ring which cooperates with a stop in the base. A cover is provided rotatably attached to the base having a single pill exit opening formed thereon. The cover is also provided with a plurality of ratchet teeth which cooperates with the knurled ring and the base for advancing the pill exit into alignment with successive compartments to allow the removal of individual pills therefrom.

Child-resistant pill dispenser, U.S. Pat. No. 4,069,942 (priority Jul. 12, 1976), provides a pill dispenser with internal capabilities of dispensing only a selected one of a plurality of pills at a given time, and closure mechanism for the dispenser incorporates a child-resistant safety-locking feature in addition to providing threaded closure and sealing of the dispenser. The body of the dispenser has plural spaced compartments for unit-pill retention, and the closure mechanism coacts with the dispenser to assure a fully closed condition of each and every pill compartment, when the closure is secured.

Pill dispenser with indicating means, U.S. Pat. No. 3,579,883 (priority Feb. 4, 1969), provides a pill dispenser with indicating means in the form of a flexible strip having a plurality of day indicia which are selectively adjustable to align any set of a predetermined number of successive indicia with a like number of columns of pills, thereby providing an indication of when each pill is to be taken.

If a pill dispenser could provide guidance to an elderly or disabled user regarding the precise timing of the dose, such a device would be useful, and would be well received. A pill dispenser system for before and after meals, which provides seven pill dispensers corresponding to the days of the week and two separate compartments corresponding to each meal of the day, would resolve this problem.

### SUMMARY OF THE INVENTION

Accordingly, the invention is directed to a pill dispenser system for before and after meals. The system provides seven pill dispensers, corresponding to the days of the week and identifiable by printed tabs, which are provided. Each pill dispenser provides four sections, each corresponding to a meal or snack which is served during the course of a day. Each section further provides two compartments with tight fitting snap-down lids, corresponding to the period before and after each meal or snack. The pill dispensers are provided on a tray in sets of seven, corresponding to the seven days of the week. The tray provides a hinged tray lid which may be secured by a latch.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 is a top view of the first exemplary embodiment with the tray removed, displaying the pill dispensers 10.

FIG. 2 is a front perspective view of the first exemplary embodiment with the tray removed, displaying the pill dispensers 10.

FIG. 3 is a side view of a pill dispenser of the first exemplary embodiment, displaying the pill dispenser 10.

FIG. 4 is a side perspective view of a pill dispenser of the first exemplary embodiment, displaying the pill dispenser 10, the tab 11, and the sections 12.

FIG. 5 is a front view of the first exemplary embodiment with the tray removed, displaying the pill dispensers 10.

FIG. 6 is a top perspective view of a pill dispenser of the first exemplary embodiment with three lids raised, displaying the pill dispenser 10, the tab 11, the compartments 13, and the lids 14.

FIG. 7 is a top perspective view of the tray component of the first exemplary embodiment, displaying the tray 15, and the tray lid 16.

FIG. 8 is a top perspective view of the tray component of the first exemplary embodiment with the tray lid raised, displaying the tray 15, the tray lid 16, the hinge 17, and the latch 18.

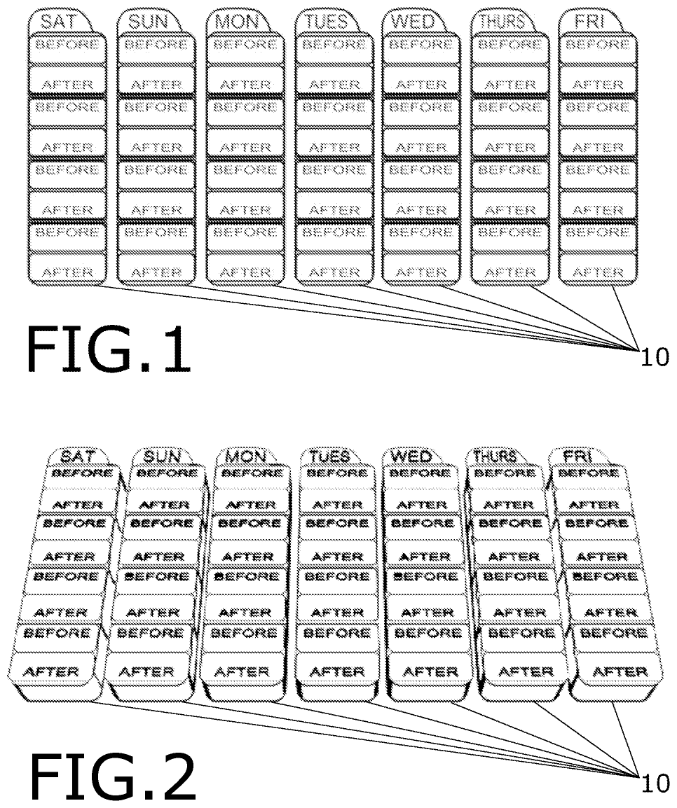

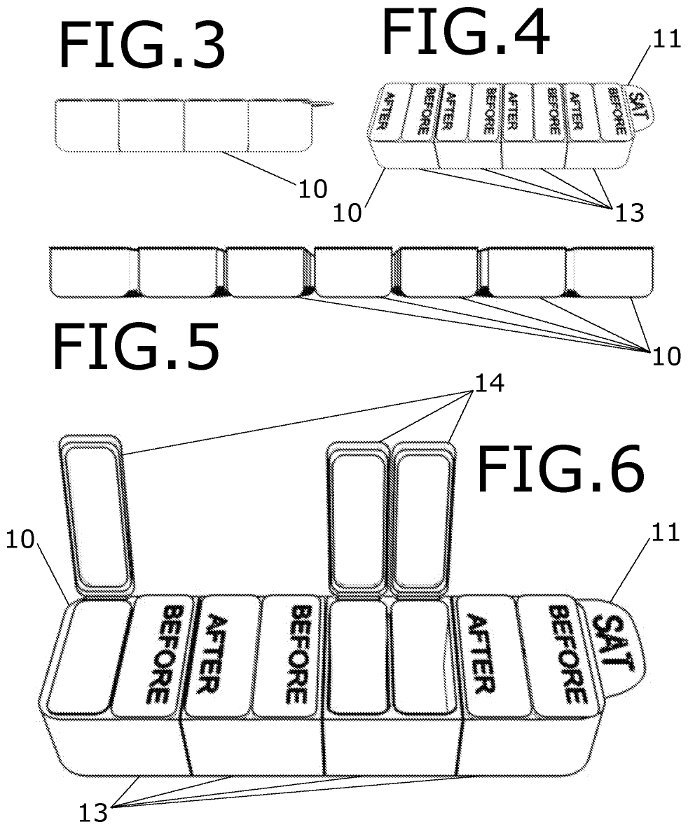

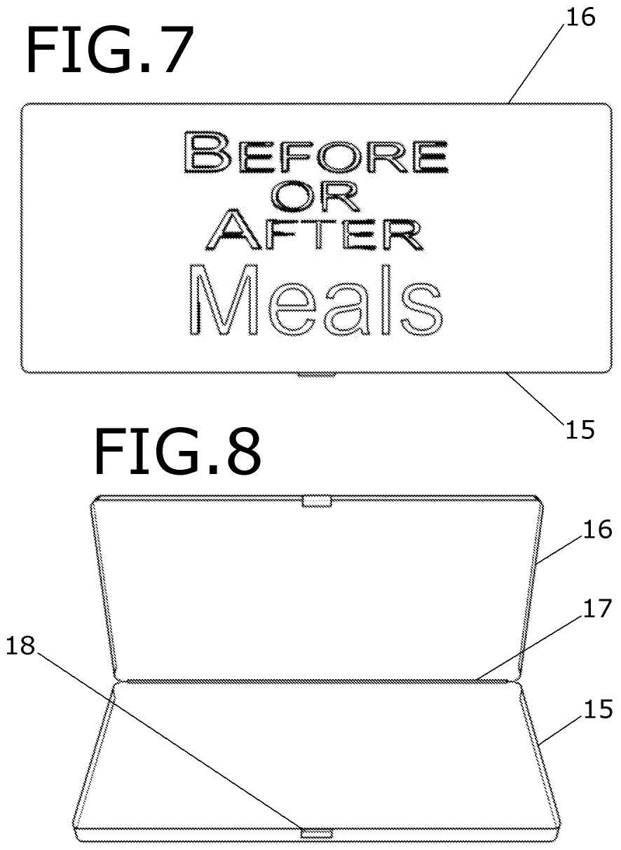

### DETAILED DESCRIPTION OF THE INVENTION

Referring now to the invention in more detail, the invention is a pill dispenser system for before and after meals.

The first exemplary embodiment is comprised of seven rectangular pill dispensers 10, each corresponding to a day of the week and identified by a large printed tab 11 which extends from the upper end of the pill dispenser 10. Each pill dispenser 10 is divided into four sections 12, each corresponding to a portion of the day: morning, lunch time, late afternoon, and evening. Each section 12 is divided into two compartments 13 wherein pills may be stored, each corresponding to before or after a meal or snack. The compartments 13 may be easily removed for more effective use, and may be transported as needed for greater convenience.

Each compartment 13 provides a tight-fitting, snap-down lid 14 which is printed in large type with the corresponding dosage time. The printed messages may be provided in any language as desired by the user.

The first exemplary embodiment is further comprised of a tray 15 which may be used to carry and store all seven pill dispensers 10. The tray 15 provides a tray lid 16, which provides a hinge 17 along the rear edge and may be secured by a latch 18.

To use the first exemplary embodiment, the user may insert pills into the compartments 13 corresponding to their prescribed dosage times, and remove the pills for consumption as indicated by the printed tabs 11 and lids 14.

The tabs 11, the compartments 13, the lids 14, the tray 15, and the tray lid 16 are preferably manufactured from rigid, durable materials, such as plastic. The hinge 17 and the latch 18 are preferably manufactured from rigid, durable materials which provide substantial structural strength, such as steel, brass, and aluminum alloy. Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

1-6. (canceled)

7. A pill dispenser, comprising:
a tray having a tray lid that opens and closes about a hinge, wherein the tray includes a tray compartment; and
seven pill dispensers adjacently positioned, in which each pill dispenser includes a tab on which an indication of a weekday is written, wherein each of the seven pill dispensers fit and are positioned within the tray compartment, and wherein the tray lid opens and closes while the seven pill dispensers are positioned within the tray compartment,
wherein each of the seven pill dispensers comprise:
four defined sections vertically aligned, each section having two compartments, a first compartment having a compartment lid labeled with an indication that signifies ‘before,’ and a second compartment having a compartment lid labeled with an indication that signifies ‘after,’ wherein the compartment lids open about a respective hinge horizontally relative to the vertical alignment of the four sections.
